(19) United States
(12) Patent Application Publication
(10) Pub. No.: US 2016/0377040 A1
(43) Pub. Date: Dec. 29, 2016

(54) FUEL INJECTION RATE MODULATION BY MAGNETOSTRICTIVE ACTUATOR AND FLUIDOMECHANICAL COUPLER

(71) Applicant: Great Plains Diesel Technologies, L.C., Ames, IA (US)

(72) Inventor: Charles B. Bright, Ames, IA (US)

(21) Appl. No.: 15/001,845

(22) Filed: Jan. 20, 2016

Related U.S. Application Data
(60) Provisional application No. 62/184,115, filed on Jun. 24, 2015.

(51) Int. Cl. F02M 51/06

(52) U.S. Cl. CPC F02M 51/0614; F02M 51/0653

(57) ABSTRACT

An improved device, system and/or method for modulating fuel injection rate through fast magnetostrictive actuation is provided. A fluidomechanical coupler uses fluid to operably couple a magnetostrictive element and a needle element. The fluidomechanical coupler permits the needle element to move from a closed position to an open position when the magnetostrictive element is actuated from a default length to an expanded length. The fluidomechanical coupler is configured to translate an input force into an output response in a direction opposite the input force. The fluidomechanical coupler includes input shafts each within an input bore and positioned adjacent to the magnetostrictive element, a movable output shaft within an output bore and positioned adjacent to the needle element, and fluid passageways connecting input bores and the output bore. Displacement of the fluid between the input bore and the output bore applies or removes a force on the output shaft.

### CROSS-REFERENCE TO RELATED APPLICATIONS

This application claims the benefit of U.S. Provisional Appl. No. 62/184,115, filed on Jun. 24, 2015, which is incorporated by reference herein in its entirety.

### FIELD OF THE DISCLOSURE

The present disclosure relates generally to fuel injection in internal combustion engines. More particularly, but not exclusively, the present disclosure relates to an improved device, system and/or method for continuously modulating fuel injection rate through fast and continuously controllable magnetostrictive actuation and a fluidomechanical coupler.

### BACKGROUND OF THE DISCLOSURE

Most contemporary internal combustion engines, including nearly all diesel fuel engines, use fuel injectors to mix fuel and air prior to combustion. Spark ignition engines generally mix the fuel and air prior to compression. By contrast, diesel fuel engines compress the air first, after which fuel is injected directly into the engine cylinder. Diesel engines do not use spark plugs, but rather rely on the increased temperature associated with the highly compressed air to ignite the air-fuel mixture. As a result, the characteristics associated with the air-fuel mixture (e.g., fuel metering, fuel atomization, etc.) define the performance of the diesel engine, making the fuel injector of paramount importance. Further, the high injection pressures require system component designs and materials capable of withstanding higher stresses in order to perform for extended durations and match the engine's durability targets. There is a need in the art for an improved fuel injector that more precisely controls the flow rate, dispersion, and timing of fuel injection within the cylinder without sacrificing durability.

Over the years, much innovation has gone into improving the control of direct fuel injection. Two technologies have occupied the primary areas of research and development—electromagnetic solenoids and piezoelectric ceramics. Electromagnetic solenoids consist of an electromagnetically inductive coil wound around an armature. The coil is shaped such that the armature can be moved in and out of the center to provide a mechanical force to open and close the fuel injector. Solenoids offer enhanced durability and reliability, but are unsuitable for continuous control. In particular, the mechanical motion generated by the solenoid can never be proportional to the electrical input. Therefore, the solenoids are unable to effectively produce ideal fuel rate shapes or quick jets with minimal delay. Rather, by its operating principle, when a magnetic flux above a threshold value crosses an air gap, the two poles of the solenoid accelerate towards one another. The two poles close the gap and impact each other and often bounce back. The electromagnetic force that accelerates the two poles is inversely proportional to the square of the gap distance between the two poles, making velocity and position control difficult. Thus, the solenoid is either open, closed, bouncing, or transitioning between these states at a more or less uncontrollable rate.

In contrast to electromagnetic solenoids, piezoelectric ceramics utilize the principle of internal generation of a mechanical strain from an applied electrical field. Certain crystalline materials generate changes from their static dimension when an external electric field is applied to the material. The key feature to this technology is that mechanical expansion is generally proportional to the applied voltage. As a result, piezoelectric ceramics offer speed and infinitely adjustable displacement within their expansion range, permitting continuous control over fuel injection. In particular, piezoelectric ceramics can provide for faster and smaller pulse injections to reduce in-cylinder formation of diesel emissions. However, an inherent defect of piezoelectric ceramics is susceptibility to performance degradation and limited working life. This is of less concern when lightly loaded, yet the demands associated with diesel fuel injection (i.e., heightened temperatures and pressures) render piezoelectric ceramics less than ideal for rate shaping fuel injection. Further, piezoelectric ceramics can disadvantageously become inoperable by depoling if a voltage applied is reverse to the original polarity.

In the 1970s, the United States Navy developed Terfenol-D, an intermetallic alloy of iron and the rare earth elements terbium and dysprosium. The material is one of the best known exhibitors of the property of magnetostriction. The property results from ferromagnetic materials changing their shape or dimensions during the process of magnetization. In other words, magnetostrictive materials couple a magnetic input to a mechanical output. The mechanical expansion is proportional to the magnitude of the current sheath circulating around the magnetostrictive element, regardless of direction of the circulating current. The behavior of magnetostrictive materials combines the advantages of both electromagnetic solenoids and piezoelectric ceramics without the shortcomings of either. In particular, magnetostrictive materials offer speed and infinitely adjustable displacement within their operating range, as well as the durability to survive the demands of the diesel fuel injection environment. The expansion associated with magnetostriction does not fatigue the material and any temperature effects do not permanently degrade the alloy.

Precision fuel injection requires precision control of a needle position throughout the entire fuel injection event. Fuel injectors using magnetostrictive actuators are typically limited to a narrow range of operating conditions. Therefore, a need exists in the art for a fuel injector that can precisely control the needle position throughout the entire fuel injection event at any combination of load and speed of any internal combustion engine.

### SUMMARY OF THE DISCLOSURE

A primary object, feature, and/or advantage of the present disclosure is to improve on or overcome the deficiencies in the art.

Another object, feature, and/or advantage of the present disclosure is to provide a fuel injector that can precisely control the needle position throughout the entire fuel injection event at any combination of load and speed of any internal combustion engine. A magnetostrictive actuator and fluidomechanical coupler replace the solenoid actuator and hydromechanical valve components on a production fuel injector. The magnetostrictive actuator converts voltage and current input into displacement and force output that can be finely controlled.

Still another object, feature, and/or advantage of the present disclosure is a component that couples the magnetostrictive actuator and the needle via fluid, preferably fuel. The fluidomechanical coupler converts the expansion of the magnetostrictive actuator into a retraction of the needle, which can require translating an input force in one direction to an output response in an opposite direction. The forces on the fluidomechanical coupler from fuel pressure are substantially balanced with the forces associated with the magnetostrictive actuator, thus providing precise control the rate of fuel injection through minimal change in a ratio of forces.

Still yet another object, feature, and/or advantage of the present disclosure is to continuously and variably control the electrical input to the magnetostrictive actuator such that the fluidomechanical coupler permits the needle to open and close quickly or slowly, thereby injecting small amounts or large amounts, at any desired and variable rate during an injection event.

Another object, feature, and/or advantage of the present disclosure is to preload the magnetostrictive element with the fluidomechanical adapter to prevent tensile stress failure during operation. The fluidomechanical adapter can use fuel as its medium to supply the necessary compressive preload for the magnetostrictive element within the actuator assembly.

These and/or other objects, features, and advantages of the present disclosure will be apparent to those skilled in the art. The present disclosure is not to be limited to or by these objects, features and advantages. No single embodiment need provide each and every object, feature, or advantage.

According to an aspect of the disclosure, an improved fuel injector is provided. The fuel injector includes a magnetostrictive element operably connected to a solenoid coil. The magnetostrictive element has a default length, an expanded length, and any number of lengths between the two. A nozzle is disposed at a terminal end of the fuel injector. A needle element is disposed proximate to the terminal end of the fuel injector and movable between a closed position and an open position. A fluidomechanical coupler is provided. The fluidomechanical coupler uses fluid to operably couple the magnetostrictive element and the needle element. The fluidomechanical coupler is configured to permit the needle element to move from the closed position to the open position when the magnetostrictive element is actuated from the default length to the expanded length.

The needle element can be moved from the closed position to the open position, at least in part, by forces on the needle element generated by high pressure fuel. The fluidomechanical coupler is configured to translate an input force into an output response in a direction opposite the input force. The fluid within the fluidomechanical coupler can be fuel. The fluid pressurized within the fluidomechanical coupler can preload the magnetostrictive element. The length of the magnetostrictive element is selectively variable between the default length and expanded length to selectively position the needle element at any point between the closed position and the open position.

According to another aspect of the present disclosure a fuel injector includes a magnetostrictive element electromagnetically coupled to a solenoid coil, a needle element configured to selectively open a nozzle, and a fluidomechanical coupler using fluid to operably couple the magnetostrictive element and the needle element. The fluidomechanical coupler includes an input shaft slidably disposed within an input bore. The input shaft is positioned adjacent to the magnetostrictive element. The fluidomechanical coupler includes an output shaft slidably disposed within an output bore and positioned adjacent to the needle element. A fluid passageway connects to the input bore and the output bore.

A biasing element can be operably connected to the needle element and configured to bias the needle element to a closed position. The fluid within the output bore moves the output shaft to permit high pressure fuel to overcome the biasing element (and high pressure fuel adjacent to the output shaft) and force the needle element to an open position. Displacement of the fluid between the input bore and the output bore applies or removes a force on the output shaft.

According to yet another aspect of the present disclosure, a method for injecting high pressure fuel is provided. A fuel injector is provided having a magnetostrictive element electromagnetically connected to a solenoid coil, a fluidomechanical coupler, a needle element, and a nozzle. The solenoid coil is energized to cause expansion of the magnetostrictive element or deenergized to cause contraction (from an expanded length) of the magnetostrictive element. Fluid is displaced within the fluidomechanical coupler by the expansion or contraction of the magnetostrictive element. The displaced fluid causes an output response by the fluidomechanical coupler in a direction opposite the expansion or contraction of the magnetostrictive element.

The output response of the fluidomechanical coupler can be in the direction opposite the expansion of the magnetostrictive element and permits the high pressure fuel to move the needle element to open the nozzle. The expansion or the contraction of the magnetostrictive element can be selectively controlled to variably control magnitude of fluid displacement and the output response of the fluidomechanical coupler, thereby controlling rate of fuel injection. The fuel injector can be installed on a diesel fuel engine.

### BRIEF DESCRIPTION OF THE DRAWINGS

Illustrated embodiments of the disclosure are described in detail below with reference to the attached drawing figures, which are incorporated by reference herein, and where:

FIG. 1 is a perspective view of a fuel injector in accordance with an illustrative embodiment of the present disclosure;

FIG. 2 is a cross-sectional view of the fuel injector of FIG. 1 taken along section lines 2-2;

FIG. 3 is a perspective view of a magnetostrictive element, end caps, and a fluidomechanical coupler in accordance with an illustrative embodiment of the present disclosure;

FIG. 4 is a perspective view of a fluidomechanical coupler in accordance with an illustrative embodiment of the present disclosure;

FIG. 5 is a detailed view of the fluidomechanical coupler of FIG. 3 within circle 5-5; and

FIG. 6 is a drivetrain of a fuel injector in accordance with an illustrative embodiment of the present disclosure.

### DETAILED DESCRIPTION

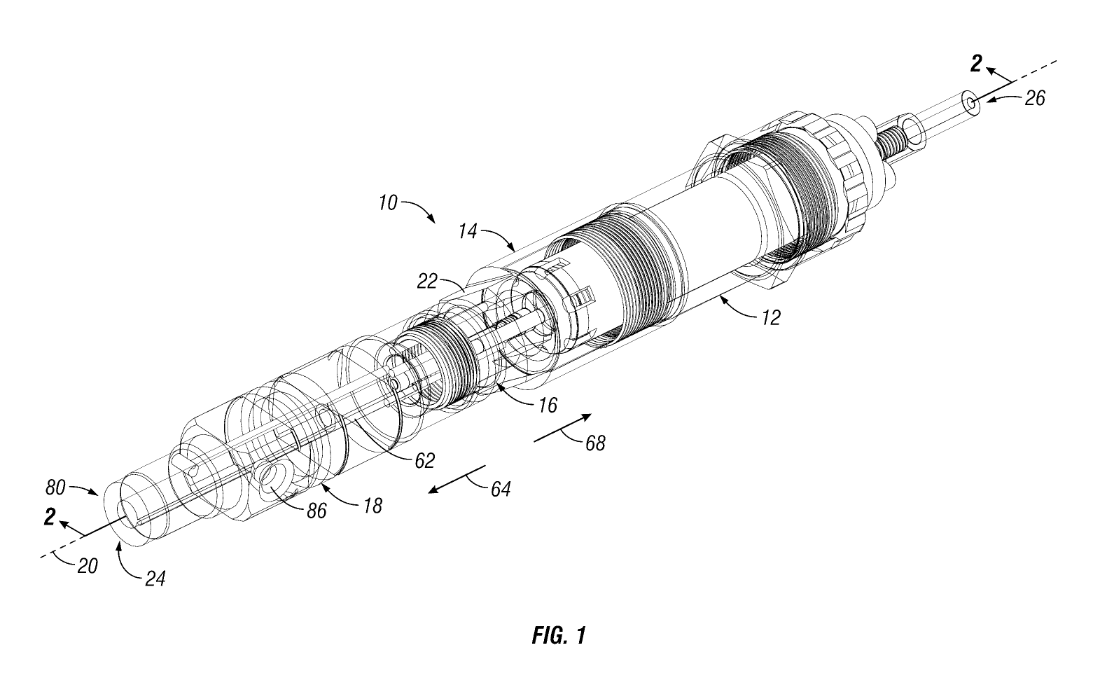

FIG. 1 shows a fuel injector 10 in accordance with an illustrative embodiment of the present disclosure. The fuel injector 10 includes an actuator assembly 12, a retention housing 14, a fluidomechanical coupler 16, and an injector housing 18. At least the actuator assembly 12, the retention housing 14, and/or the injector housing 18 can be threadably connected to one another, as illustrated in FIG. 1, or secured via other means commonly known in the art. Further, the actuator assembly 12, the retention housing 14, the fluidomechanical coupler 16, and the injector housing 18 can be generally disposed coaxial to one another along a major axis 20 of the fuel injector 10 between a nozzle end 24 and a connection end 26. The retention housing 14 is generally positioned between the actuator assembly 12 and the injector housing 18, and includes one or more alignment surfaces 22 to ensure proper installation and prevent rotation of the fuel injector 10 within an internal combustion engine (not shown), preferably a diesel engine.

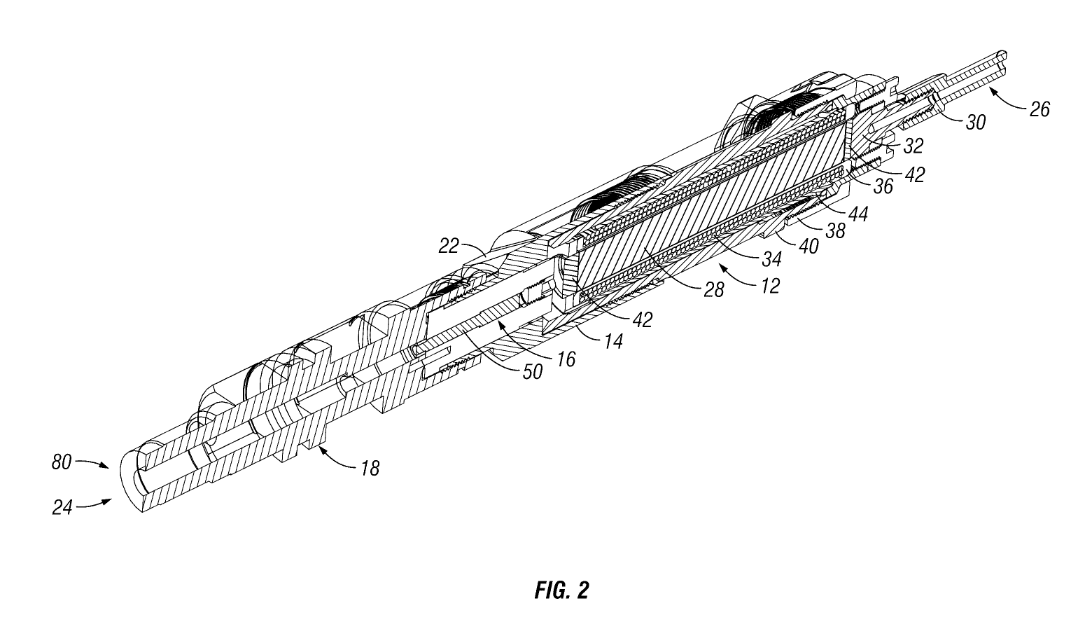

Referring to FIGS. 1 and 2, the actuator assembly 12 is positioned proximate to the connection end 26 of the fuel injector 10. The actuator assembly 12 generally includes the components required to receive an electrical input to actuate the magnetostrictive element 28 of the actuator assembly 12. To that end, the actuator assembly 12 includes a fitting 30 threadably connected to a tail 32. The tail 32 is configured to secure one or more wire leads (not shown) to the solenoid coil 34. As commonly known in the art, the solenoid 34 coil is energized via the wire leads. A tail retainer 38 can secure the tail 32 to an actuator assembly housing 40.

The solenoid coil 34 can include one or more windings of conductive wire. In the exemplary embodiment illustrated in FIG. 2, the solenoid coil 34 has two windings. The solenoid coil 34 can be wound about a bobbin 36 comprised of non-conductive material. Thus, the bobbin 36 is coaxially disposed between the solenoid coil 34 and the magnetostrictive element 28.

The magnetostrictive element 28 can be comprised of an alloy including one or more rare earth and/or transition elements. More specifically, the alloy can be formed of grain-oriented polycrystalline rare earth and/or transition metal materials of the formula TbₓDyₓ₋₁Fe_{2-w}, wherein 0.20≦x≦1.00 and 0≦w≦0.20. The grains of the material have their common principal axes substantially along the growth axis of the material. As the alloy has its grain oriented in the axial direction, the favored direction of magnetostrictive response of the magnetostrictive element 28 is formed into a shape with ends that are substantially parallel to each other and substantially perpendicular to the favored direction of magnetostrictive response. The magnetostrictive element 28 can have a transverse dimension perpendicular to the direction of magnetostrictive response substantially smaller than one-quarter wavelength at the electromechanical resonant frequency of the apparatus. The magnetostrictive element 28 can have a length in the direction of magnetostrictive response of no greater than one-quarter wavelength at the electromechanical resonant frequency of the apparatus. The magnetostrictive element 28 has a default length and is configured to expand to an expanded length, and/or selectively expandable to any length between the default length and the expanded length to selectively control the rate of fuel injection.

In an exemplary embodiment, the magnetostrictive element 28 is elongated or rod-shaped. In a preferred embodiment, the magnetostrictive element 28 is cylindrical, but the present disclosure contemplates the shape can be an ellipsoid, parallelepiped, prismatic, or other similar or suitable shapes. To guard against fracture of the magnetostrictive element 28, an end cap 42 can be secured to each end of the magnetostrictive element 28. Preferably, the end caps 42 are made of a hardened, ferromagnetic material to minimize flux divergence at the rod ends. Epoxy can bond the outside diameter edge of the end caps 32 to prevent chipping. The end caps 42 distribute the load across the face of the magnetostrictive element 28 through the compliant epoxy used for bonding.

To minimize the energy required to generate a field strength sufficient to excite the magnetostrictive element 28, a return flux path 44, preferably of ferromagnetic material, is provided to guide the lines of magnetic force around the outside of the solenoid coil 34 from one end of the magnetostrictive element 28 to the other.

The technical operation of the magnetostrictive element 28 is described in co-pending, co-owned U.S. patent application Ser. No. 14/174,560, filed on Feb. 6, 2014, and Ser. No. 14/577,240, filed on Dec. 14, 2014, both of which are incorporated herein by reference in their entireties. In short, a voltage waveform of one polarity is applied, inducing a current waveform of matching polarity to flow through solenoid coil 34. The current within solenoid coil 34 establishes a magnetic field of matching polarity. This magnetic field generates magnetic lines of force that cross into the magnetostrictive element 28 with corresponding magnetic flux density of matching polarity. Lines of magnetic flux close back on themselves through the flux return path 44 which, together with the magnetostrictive element 28, forms a complete magnetic circuit. The magnetic flux waveform within the magnetostrictive element 28, regardless of polarity, causes a corresponding axial expansion. The continuous control of the current into solenoid coil 34 continuously controls the axial expansion or contraction of the magnetostrictive element 28. The rate at which current increases or decreases and its maximum magnitude are both converted by the magnetostrictive element 28 into corresponding mechanical displacement. As used herein, “contract” or “contraction” refer to the shortening of the magnetostrictive element 28 from a length greater than the default length.

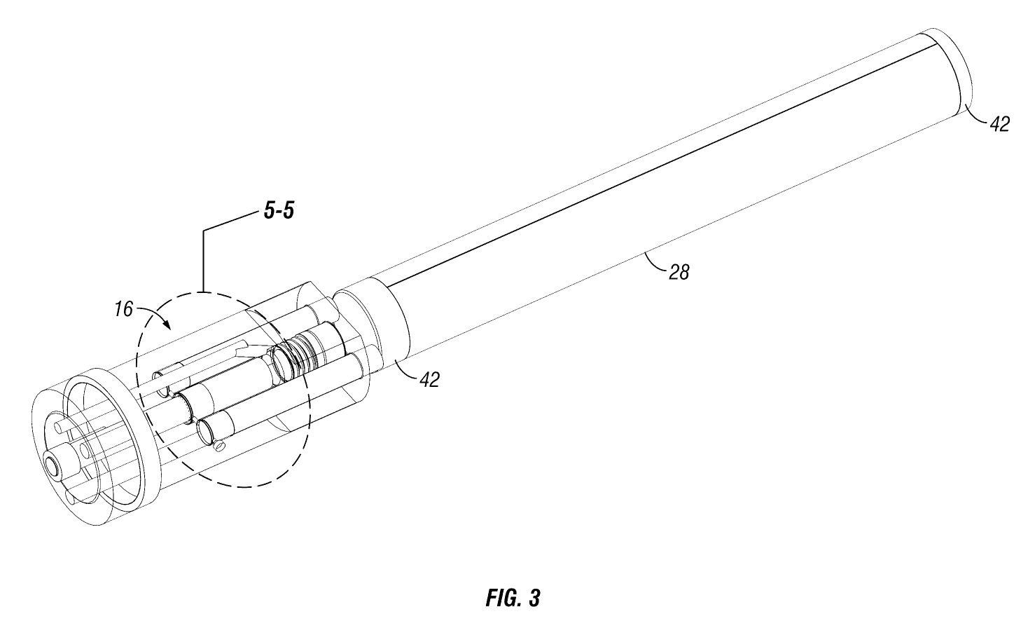

To achieve the advantages of magnetostrictive actuation of a fuel injector, the expansion and contraction of the magnetostrictive element 28 must be translated into a corresponding output that provides for precise and variable control over fuel injection. To that end, the fluidomechanical coupler 16 is provided. The fluidomechanical coupler 16 can be disposed at least partially within the retainer housing 14 and/or the injector housing 18 proximate to an end of actuator assembly 12, as illustrated in FIG. 2. More particularly, the fluidomechanical coupler 16 is positioned adjacent to an end cap 42 associated with one end of the magnetostrictive element 28, as illustrated in FIG. 3. As disclosed in detail herein, the expansion and contraction of the magnetostrictive element 28 results in an input force and/or an output response from the fluidomechanical coupler 16.

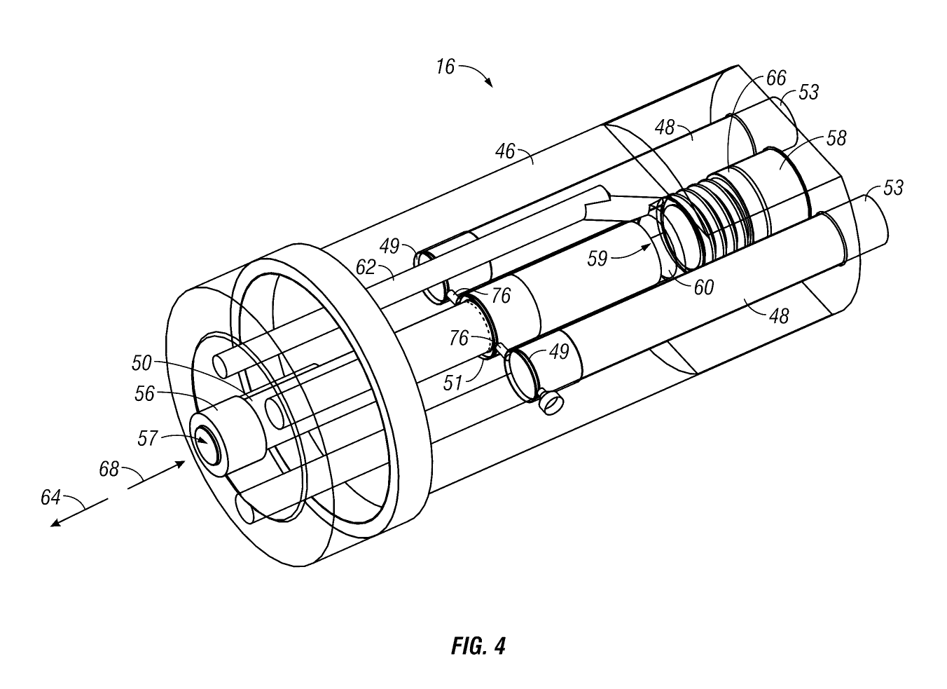

FIG. 4 illustrates a fluidomechanical coupler 16 in accordance with an exemplary embodiment of the present disclosure. The fluidomechanical coupler 16 includes a plumbing block 46 or housing within which the components of the fluidomechanical coupler 16 are disposed. While FIG. 4 shows the plumbing block 46 as transparent, this is for illustrative purposes only. The plumbing block 46 is constructed of a metal and/or other suitable material capable of handling the temperatures and/or pressures associated with the operation of the fluidomechanical coupler 16 and the fuel injector 10 generally.

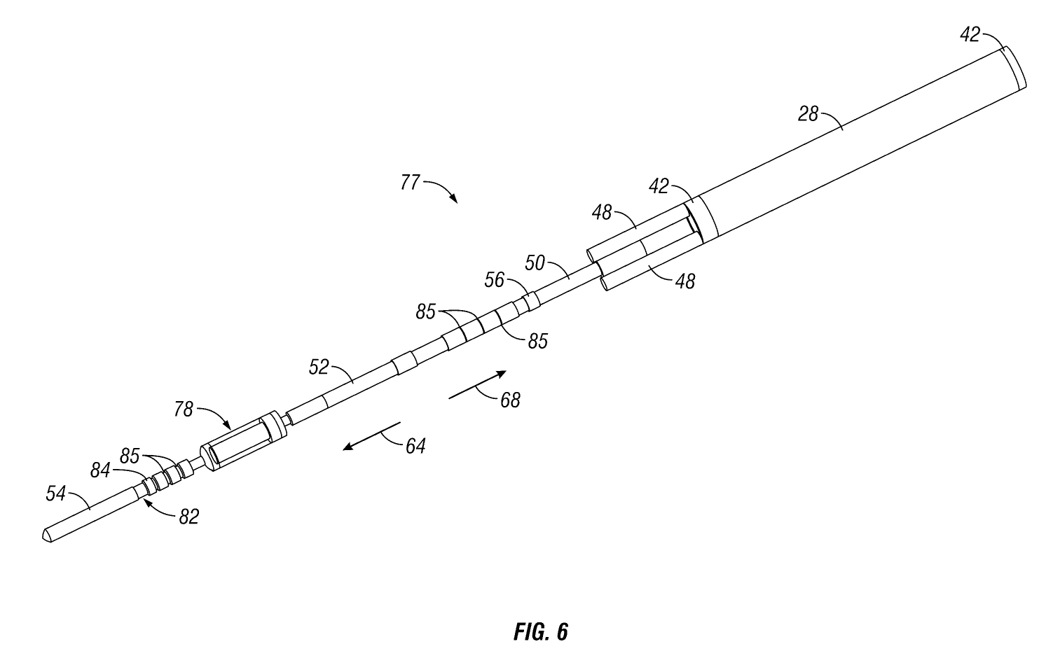

At least one input shaft 48 is movably disposed within input bores 49 of the plumbing block 46 and configured to receive an input force from the actuator assembly 12, particularly the magnetostrictive element 28. In a preferred embodiment, the fluidomechanical coupler 16 has two input shafts 48. The input shafts 48 can be elongated cylinders, as illustrated in FIG. 4, or of any suitable size and/or shape without deviating from the objects of the present disclosure. Input needle stops 53 can be associated with ends of the input shafts 48 to ensure proper axial positioning of the input shafts 48 within the plumbing block 46. Similarly, an output shaft 50 is movably disposed within output bores 51 of the plumbing block 46 and configured to provide an output response based, at least in part, on the input force to the input shafts 48. The output shaft 50 can be a staged elongated cylinder, as illustrated in FIG. 4, or of any suitable size and/or shape without deviating from the objects of the present disclosure. The output shaft 50 can be generally coaxial to the quill 52 and/or needle element 54 (see FIG. 6), and substantially positioned along the major axis 20 of the injector 10. An output needle stop 56 can be connected to an end 57 of the output shaft 50 to provide for proper interfacing between the output shaft 50 and the quill 52 as well as to ensure proper axial positioning of the output shaft 50 within the plumbing block 46. As illustrated in FIG. 3, the input shafts 48 can be oriented parallel to the output shaft 50 and positioned radially within the plumbing block 46 from the major axis 20 relative to the output shaft 50.

The fluidomechanical coupler 16 includes a cap 58 disposed within the plumbing block 46. The cap 58 can be threadably engaged to an interior of the plumbing block 46 and positioned proximate to an end 59 of the output shaft 50 opposite the needle stop 56, as illustrated in FIG. 4. The cap 58 is dimensioned and positioned so as to provide a void 60 between the cap 58 and the end 59 of the output shaft 50. The void 60 is in fluid communication with a high pressure fuel supply (not shown) via the main fuel rail 62. As a result, the void 60 is generally filled with high pressure fuel, which places a force on the output shaft 50 in a direction generally represented by arrow 64. A seal 66, such as a brass ring or the like, can be associated with the cap 58 to prevent leakage of the high pressure fuel from the plumbing block 46. The forces on the output shaft 50 (in the direction of arrow 64) are substantially counteracted by the force on the output shaft 50 by the quill 52 and needle 54 in a direction generally represented by arrow 68, which will be discussed in detail below.

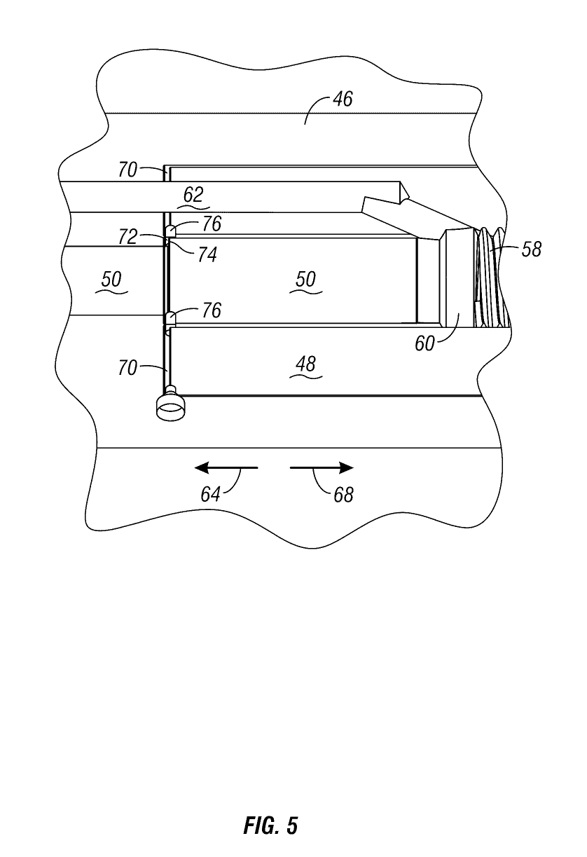

Referring to FIGS. 4 and 5, the fluidomechanical coupler 16 is designed such that fluid is disposed within a portion of the input bores 49 and/or the output bores 51. In particular, fluid is disposed within a gap 70 within the input bores 49 adjacent the end of the input shafts 48 and/or a gap 72 within the output bore 51 adjacent to a flanged surface 74 extending around the output shaft 50. The input shafts 48 and the output shaft 50 are operably connected by channels 76 or fluid passageways extending between the input bores 49 and the output bore 51. The channels 76 are configured to permit displacement of fluid between the input bores 49 and the output bore 51 during operation of the fluidomechanical coupler 16. In a preferred embodiment, the fluid is a portion of the high pressure fuel in the void 60 that effectively leaks into the gaps 70, 72 based on the pressure and/or tolerances between the input shafts 48 and the input bores 49 and/or the output shaft 50 and the output bore 51.

Upon an input force to the input shafts 48 (in the direction of arrow 64), the input shafts 48 move within the input bore 49 in the same direction. The fluid within the gap 70 is displaced through the channels 76 into the gap 72 within the output bore 51 proximate to the flanged surface 74 of the output shaft 50. The fluid generates a force on the flanged surface 74, and thus on the output shaft 50 generally, in a direction of arrow 68. Based on the unique force balance of the fuel injector 10, discussed in detail below, the force moves the output shaft 50 in the direction of arrow 68. Conversely, when the input force is removed from the input shafts 48, the unique force balance of the fuel injector 10 results in the output shaft 50 moving in the direction of arrow 66. The flanged surface 74 of the output shaft 50 displaces fluid from gap 72, through the channels 76, into the gap 70 of the input bore 49. The input shafts 48 are forced in a direction of arrow 68. Taken together, the fluidomechanical coupler 16 is configured to translate an input force into an output response in a direction opposite the input force.

With the advantageous structure of function of the fluidomechanical coupler 16 developed, reference is made to FIG. 6. FIG. 6 illustrates the so-called drivetrain 77 of the fuel injector 10. The drivetrain 77 can include the magnetostrictive actuator 28 (with or without end caps 42), input shafts 48, output shaft 50, needle stop 56, quill 52, biasing element 78, and needle element 54. The drivetrain 77 is disposed within the various housings of the fuel injector 10 as disclosed herein and as partially illustrated in FIGS. 1 and 2. Referring to FIGS. 1 and 2, the quill 52, biasing element 78, and needle element 74 are not shown, but it can be appreciated that the quill 52 is positioned adjacent to the output shaft 50. The quill 52, biasing element 78, and needle element 54 are disposed within the injector housing 18. A nozzle 80 is associated with the fuel injector 10 at the nozzle end 24. The needle element 54 is positioned proximate to the nozzle end 24 and moveable between a closed position and an open position. In the closed position, the needle element 54 obstructs the nozzle 80 such that no fuel is permitted to be ejected from the fuel injector 10. In the open position, the needle element 54 is moved (in the direction of arrow 68) such that high pressure fuel is injected from the fuel injector 10 into the internal combustion engine (not shown).

The biasing element 78 is operably connected to the needle element 54 and configured to bias the needle element 54 in the closed position. The biasing element 78 can include a compression spring and/or shim. In the illustrated embodiment of FIG. 6, the biasing element 78 is disposed between the needle element 54 and the quill 52.

As illustrated in FIG. 6, the needle element 54 has a neck portion 82 and a head portion 84. When installed within the injector housing 18, the neck portion 82 is positioned proximate to the main fuel rail inlet 86 (see FIG. 1) fluidly connected to the main fuel supply. Based on the difference in outer diameters between the neck portion 82 and the head portion 84, the high pressure fuel entering the fuel injector through the main fuel rail inlet 86 imposes a force on the needle element 54 in the direction of arrow 68. Grooves 85 generally keep the needle element 54 and/or the quill 52 (and/or other moving structure) centered within their respective bores. More particularly, the grooves 85 permit pressure associated with the high pressure fuel to redistribute itself evenly around the circumference(s) of the needle element 54 and/or the quill 52, thereby preventing friction between the structure(s) and their bores. To a lesser extent, the high pressure fuel within the grooves 85 can further provide force urging a portion of the drivetrain 77 (i.e., the needle element 54, the quill 52, and output shaft 50) in a direction of arrow 68 to move the needle element 54 to the open position.

The unique force balance mentioned herein is described as follows. The following structures generally urge the needle element 54 to the closed position (“closing forces”)(i.e., in the direction of arrow 64): (a) fuel rail pressure from the fuel within the void 60 impose a force on the output shaft 50; and (b) the biasing element 78. The fuel rail pressure acting on the needle element 54 and/or the quill 52 generally urge the needle element to the open position (“opening forces”)(i.e., in the direction of arrow 68). The forces are substantially balanced, but the closing forces slightly exceed the opening forces such that the fuel injector 10 is closed by default, and more particularly, when the magnetostrictive element 28 is at a default length.

In operation, the fluidomechanical coupler 16 operably couples the magnetostrictive element 28 to the needle element 54. The fluidomechanical coupler 16 is configured to permit the needle element 54 to move from the closed position to the open position when the magnetostrictive element 28 is actuated from the default length to the expanded length. As the solenoid 34 is energized and the magnetostrictive element 28 expands, the end cap 42 moves the input shafts 48 within the input bores 49 in the direction of arrow 64. The fluid within the gap 70 of each of the input bores 49 (and/or the gap 72 of the output bore 51) is displaced into the output bore 51. The increased fluid within the output bore 51 provides sufficient force to the flanged surfaces 74 of the output shaft 50 to overcome the forces associated with fuel rail pressure within the void 60 and the biasing element 78 (i.e., opening forces exceed closing forces). As a result, the output shaft 50 is urged in the direction of arrow 68, including the end 57 of the output shaft 50. The quill 52, which is positioned adjacent to and held in direct contact with the end 57 of the output shaft 50, is urged in the direction of arrow 68 due to the high pressure fuel within the main fuel rail 62 in fluid contact with the quill 52, and more particularly the grooves of the quill 52. Similarly, the needle element 54, which is positioned adjacent to and held in direct contact with the quill 52, is urged in the direction of arrow 68 due to the high pressure fuel within the main fuel rail 62 in fluid contact with the needle element 54, and more particularly the head portion 84 and grooves of the needle element 54. The needle element 54 moves from the closed position to the open position, after which high pressure fuel within the main fuel line 62 is injected through the nozzle 80 to the internal combustion engine.

After the completion of the injection event, the solenoid 34 is deenergized, and the magnetostrictive element 28 contracts (i.e., from the expanded length) and/or returns to the default length. Due to the contraction of the magnetostrictive element 28, the magnetostrictive element 28 no longer forces the input shafts 48 to displace the fluid through the channels 76 into the output bore 51. Rather, the forces on the end 59 of the output shaft 51 from the high pressure fuel within the void 60 (together with the biasing element 78) overcome the forces associated with the high pressure fuel within the main fuel rail 62 in fluid contact with the needle element 54 and/or the quill 52 (i.e., closing forces exceed opening forces). As a result, the needle element 54 returns from the open position to the closed position. Further, the movement of the output shaft 50 in a direction of arrow 64 causes the flanged surface 74 to displace at least a portion of the fluid within the output bore 51 into the channels 76 and the input bores 49. The pressure of the fluid within the input bores 49 forces the input shafts 48 in the direction of arrow 48 such that the input shafts 48 remain adjacent to and/or in direct contact with the end caps 42 of the magnetostrictive element 28. Taken together, displacement of the fluid between the input bores 49 and the output bore 51 applies or removes a force on the output shaft 50.

The input shafts 48, which remain adjacent to and/or in direct contact with the end caps 42 of the magnetostrictive element 28, also provide a constant compressive force on the magnetostrictive element 28. This advantageous feature of the fluidomechanical coupler 16 results in a compressive preload on the magnetostrictive element 28 and prevents tensile failure during operation. Further, the magnetostrictive element 28 has a default length and is configured to expand to an expanded length, and/or selectively expandable to any length between the default length and the expanded length to selectively control the rate of fuel injection. Selectively controlling the expansion or contraction of the magnetostrictive element 28 variably controls the magnitude of fluid displacement between the input bores 49 and the output bore 51, thereby selectively controlling the rate of fuel injection.

The disclosure is not to be limited to the particular embodiments described herein. In particular, the disclosure contemplates numerous variations in which the fluidomechanical coupler can translate an input force from a magnetostrictive actuator into an output response to provide precise control over fuel injection. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the disclosure. It is understood that any other modifications, substitutions, and/or additions can be made, which are within the intended spirit and scope of the disclosure. For the foregoing, it can be seen that the disclosure accomplishes at least all that is intended.

The previous detailed description is of a small number of embodiments for implementing the disclosure and is not intended to be limiting in scope. The following claims set forth a number of the embodiments of the disclosure with greater particularity.

What is claimed is:

1. A fuel injector comprising:
a magnetostrictive element operably connected to a solenoid coil and having a default length and an expanded length;
a nozzle disposed at a terminal end of the fuel injector;
a needle element disposed proximate to the terminal end of the fuel injector and movable between a closed position and an open position; and
a fluidomechanical coupler using fluid that operably couples the magnetostrictive element and the needle element and configured to permit the needle element to move from the closed position to the open position when the magnetostrictive element is actuated from the default length to the expanded length.

2. The fuel injector of claim 1 further comprising a biasing element operably connected to the needle element and configured to bias the needle element in the closed position.

3. The fuel injector of claim 1 wherein the needle element is moved from the closed position to the open position, at least in part, by forces on the needle element generated by high pressure fuel.

4. The fuel injector of claim 1 wherein the fluidomechanical coupler is configured to translate an input force and motion into an output response in a direction opposite the input force.

5. The fuel injector of claim 1 wherein the fluidomechanical coupler includes an output shaft coaxial to the needle element.

6. The fuel injector of claim 5 wherein the fluidomechanical coupler further includes at least one input shaft oriented parallel to the output shaft and positioned radially from a coaxial axis relative to the output shaft.

7. The fuel injector of claim 6 wherein the at least one input shaft comprises two input shafts.

8. The fuel injector of claim 6 wherein the fluidomechanical coupler further includes at least one fluid channel operably coupling the output shaft and the at least one input shaft, wherein displacement of the fluid by the at least one input shaft results in movement of the output shaft.

9. The fuel injector of claim 1 wherein the fluid within the fluidomechanical coupler is fuel.

10. The fuel injector of claim 1 wherein the fluid pressurized within the fluidomechanical coupler preloads the magnetostrictive element.

11. The fuel injector of claim 1 wherein a length of the magnetostrictive element is selectively variable between the default length and expanded length to selectively position the needle element at any point between the closed position and the open position.

12. A fuel injector comprising:
a magnetostrictive element electromagnetically coupled to a solenoid coil;
a needle element configured to selectively open a nozzle;
a fluidomechanical coupler using fluid to operably couple the magnetostrictive element and the needle element, the fluidomechanical coupler having:
(a) an input shaft slidably disposed within an input bore and operably coupled to the magnetostrictive element;
(b) an output shaft slidably disposed within an output bore and operably coupled to the needle element;
(c) a fluid passageway connecting to the input bore and the output bore.

13. The fuel injector of claim 12 further comprising:
a biasing element operably connected to the needle element and configured to bias the needle element to a closed position; and
wherein the fluid within the output bore moves the output shaft to permit high pressure fuel to overcome the biasing element and force the needle element to an open position.

14. The fuel injector of claim 12 wherein displacement of the fluid between the input bore and the output bore applies or removes a force on the output shaft.

15. The fuel injector of claim 12 wherein an output response by the output shaft is in a direction opposite to an input force to fluidomechanical coupler provided by the magnetostrictive element.

16. The fuel injector of claim 12 wherein the fluid within the input bore moves the input shaft to provide a preloading force on the magnetostrictive element.

17. A method for injecting high pressure fuel comprising the steps of:
providing a fuel injector having a magnetostrictive element electromagnetically connected to a solenoid coil, a fluidomechanical coupler, a needle element, and a nozzle;
energizing the solenoid coil to cause expansion of the magnetostrictive element or deenergizing the solenoid coil to cause contraction of the magnetostrictive element;
displacing fluid within the fluidomechanical coupler by the expansion or the contraction of the magnetostrictive element; and
wherein the displaced fluid causes an output response by the fluidomechanical coupler in a direction opposite the expansion or the contraction of the magnetostrictive element.

18. The method of claim 17 wherein the output response of the fluidomechanical coupler in the direction opposite the expansion of the magnetostrictive element permits the high pressure fuel to move the needle element to open the nozzle.

19. The method of claim 17 further comprising the step of selectively controlling the expansion or the contraction of the magnetostrictive element to variably control magnitude of fluid displacement and the output response of the fluidomechanical coupler, thereby controlling rate of fuel injection.

20. The method of claim 17 wherein the fluid within the fluidomechanical coupler preloads the magnetostrictive element.

21. The method of claim 17 wherein the fluid within the fluidomechanical coupler is the high pressure fuel.

22. The method of claim 17 wherein the fuel injector is installed on a diesel fuel engine.
